(19) United States
(12) Patent Application Publication
(10) Pub. No.: US 2011/0097539 A1
(43) Pub. Date: Apr. 28, 2011

(54) Compensation element

(76) Inventors: Georg Oberndorfer, Feldkirch (AT); Sascha Dierker, Merching (DE); Mathias Goldt, Feldkirch (AT); Marc Schaeffer, Feldkirch-Nofels (AT)

(21) Appl. No.: 12/925,469

(22) Filed: Oct. 21, 2010

(30) Foreign Application Priority Data
Oct. 22, 2009 (DE) 10 2009 045 923.5

(51) Int. Cl. B32B 3/10; B32B 3/26

(52) U.S. Cl. 428/137; 428/320.2; 428/321.1

(57) ABSTRACT

A compensation element for leveling an add-on part (12) relative to a constructional component (13) has a base body (22) formed as a porous foam body in pores of which a curable material is provided.

### BACKGROUND OF THE INVENTION

1. Field of the Invention

The present invention relates to a compensation element for leveling an add-on part relative to a constructional component and having a base body provided with a curable material.

2. Description of the Prior Art

Add-on parts such as, e.g., frames, handrails, or facade elements should meet, with respect to constructional components such as floors, walls, or ceilings which, e.g., are formed of materials such as concrete or masonry, different requirements with regard to precision of their manufacturing. The add-on parts are secured to a constructional component with fastening means which includes fastening elements.

German patent publication DE 102 08 362 A1 discloses a mechanically adjustable element that serves as a compensation element and is provided with a threaded bolt that engages in the thread in a support element and is axially displaceable relative thereto for leveling the support element.

The drawback of this known solution consists in that the adjustable element requires a large space for its arrangement and its operation is expensive because of its complex constructions.

Further, massive, e.g., U-shaped disc element, which have different thicknesses and are positioned around a fastening element, are used as compensation elements. For shimming the add-on part, a number of disc elements corresponding to a predetermined height compensation, are placed one upon another. For leveling the add-on part, firstly, the add-on part is provisionally secured to the constructional component and is aligned relative thereto. After the fastening elements are released, additional disc elements are provided for separate fastening elements or excessive disc elements are removed. Then, the fastening elements are tightened again and a control measurement is carried out. As long as the alignment remains non-exact, the above-mentioned steps need to be repeated until a predetermined alignment is achieved.

The drawback of the this known solution consists in that for leveling of the add-on part, a number of operational steps are needed and, therefore, the mounting of add-on parts is time-consuming and cost-intensive.

German Patent Publication DE 10 2007 058 861 A1 discloses a compensation element for leveling an add-on part relative to a constructional component and having an elastic base body and a curable material provided in separate chambers of the base body.

The drawback of this known solution consists in that the base body should be provided with separate chambers for receiving the curable material and, as a result, the base body has inhomogeneous compressibility, which prevents an exact alignment of the add-on part.

Accordingly, an object of the present invention is to provide a compensation element for leveling an add-on part relative to a constructional component that can be easily used and, thereby, enables an exact alignment of the add-on part.

### SUMMARY OF THE INVENTION

This and other objects of the present invention, which would become apparent hereinafter, are achieved by forming the elastic base body as a foam body with open pores in which the curable material is provided.

The base body can be advantageously adapted to both the structure of a corresponding outer surface of the add-on part and the structure of a corresponding outer surface of the constructional component, and has essentially a uniform compressibility over its entire volume. Because of the curable mass being advantageously distributed over the entire volume of the base body in minute quantities, a complete curing of the base body after activation of the curable material is insured. Because of the porosity of the base body, no separate cavities, indentations, or hollow spaces need be formed in the base body for receiving the curable material.

The curable compensation element, before being cured, behaves as a rubber-like resilient material, i.e., is compressible and, thus, the position of the add-on part is easily adjustable. During curing of the curable material, the material behavior of the compensation element is transformed in behavior of a stiff rigid body in a controlled manner, so that it can withstand completely the loads generated during operation.

The curing of the compensation element is advantageously so adjusted that after initialization, a sufficient time becomes available for alignment of the add-on part by application of pressure to the compensation element and, simultaneously, the curing process is sufficiently advanced by the time the alignment is completed. In order to have a sufficient correction possibility for long add-on parts, e.g., facade elements, the curing time of the curable material should be in the range from about five to seven hours. Dependent on the application, the curing time of the curable material can be adjusted from a couple of minutes to a couple of hours. The simpler the leveling of the add-on part, the shorter the curing time of the curable material can be adjusted.

Advantageously, the base body is formed as a cuboid or a disc so that a sufficiently large bearing surface is available for bearing against the constructional component and/or against the add-on part. Further, other arbitrary changes, which match, e.g., edge conditions at the application site, can be made when shaping the base body.

Advantageously, the base body has a spring stiffness corresponding to compressibility up to 80%, whereby the expansion of the compensation element for leveling the add-on part upon release of a tightened fastening element is insured.

Advantageously, the base body is formed as a foam body with open pores, whereby the curable material can be easily arranged in the base body and be distributed therein. A compensation element with such base body is completely cured and insures absorption of loads generated during operation.

Advantageously, the base body is formed as a multi-layer body, with at least two layers having different volume density. In this way, the deformation characteristics of the base body can be influenced and controlled in an advantageous manner. This is because at least one layer with a smaller volume density is weaker in comparison with at least one other layer and, therefore, can be deformed more easily. At least one of several layers is a foam body with open pores in the pores of which a curable material is provided.

Advantageously, at least two of the layers are formed of foam bodies with open pores, and further advantageously, a certain amount of the curable material is provided in both layers. Thereby, a complete curing of the base body after the end of the curing process of the curable material is insured. With a multi-layer base body that has more than two layers, advantageously, all of the layers are formed of foam bodies with open pores which have, respectively, corresponding volume densities which correspond to the predetermined characteristics of the elastic base body. Advantageously, all of the layers are provided with a sufficient amount of curable material, so that with such base body, complete curing of the base body after the end of the curing process of the curable material is also insured.

Advantageously, at least the layer which is provided on an outer surface of the base body has a smaller volume density than the adjacent thereto layer of the base body. As a result, upon tightening of a fastening element, the base body can advantageously be adapted to the structure of the corresponding surface of the constructional component and/or the structure of the corresponding surface of the add-on part. If the surface of the constructional component and/or of the add-on part, which comes into contact with the compensation element, has projecting or protruding elements, those can easily penetrate into the layer with a smaller volume density, providing a form-locking connection between the constructional component and/or the add-on part and the compensation element.

Advantageously, the base body has a layer with a smaller volume density on both of its sides which bear against the constructional component and the add-on part, so that easily deformable sections is provided on the contact sides of the compensation element.

Advantageously, the curable material is fluid and, thus, can be easily provided in the base body, e.g., during its manufacturing. The fluid is preferably liquid and, e.g., is admixed to the material of the base body or is provided in the base body after its manufacturing. E.g., the base body is sprayed or splash with fluid, or the fluid is sprayed into the base body material through elements which penetrate thereinto.

Advantageously, the base body is soaked with fluid which advantageously can be provided with the curable material. E.g., the fluid fills a tank in which the base body is submerged or through which the base bodies are drawn. If the base body is formed as a foam body with open pores, the fluid, upon the base body being soaked with it, penetrates in the pores, insuring fine distribution of the fluid within the base body.

Advantageously, the curable material includes fluid that reacts upon contact with air, and the base body is air-tightly sealed, so that only upon removal of the seal, the curing process of the curable material begins. The air-tight sealing prevents curing of the compensation element during its transportation or storage. Advantageously, the seal includes a suitable foil that advantageously completely surrounds the base body.

Advantageously, the base body is compressible and is held in a compressed condition with removable holding means. Thereby, the base body can be easily transported, and after removal of the holding means, the compression is lifted. Due to the resulting expansion, the space between the constructional component and the add-on part is filled, providing interface therebetween. By reducing its material thickness, the base body is rolled and, finally, advantageously is packed in its compressed state with packaging means such as foil, and is kept in this state until the use of the compensation element. If the curable material is a material curable under environmental conditions, advantageously, upon expansion of the up-to-now compressed base body, a curing process-initiating medium is fed to the curable material, so that the curing process of the curable medium can start.

Advantageously, the base body is provided with a fire-retardant that in case of fire, prevents an immediate failure of the attachment of the add-on part in this region.

Advantageously, the fire-retardant includes intumescent means that expands in case of fire and at least partially prevents, if not completely, spreading of fire through a gap between the constructional component and the add-on part. Alternatively or in addition, the fire-retardant includes ablative means that cools the fastening means in case of fire.

Advantageously, at least one through-opening for a fastening element is provided in the base body, so that in the mounted condition, the compensation element surrounds the fastening element extending through the through-opening. With this arrangement of the compensation element with respect to the fastening element, an exact alignment of the add-on port in and advantageous manner becomes possible.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 an arrangement of a add-on part with two compensation elements in a mounted condition;

FIG. 2 a perspective view of one of compensation elements shown in FIG. 1;

FIG. 3 a cross-sectional view of another, than shown in FIG. 2, embodiment of a compensation element; and

FIG. 4 a cross-sectional view of a further, than shown in FIG. 2, embodiment of a compensation element.

In the drawings, basically, the same elements are designated with the same reference numerals.

### DETAILED DESCRIPTION OF THE PREFERRED EMBODIMENTS

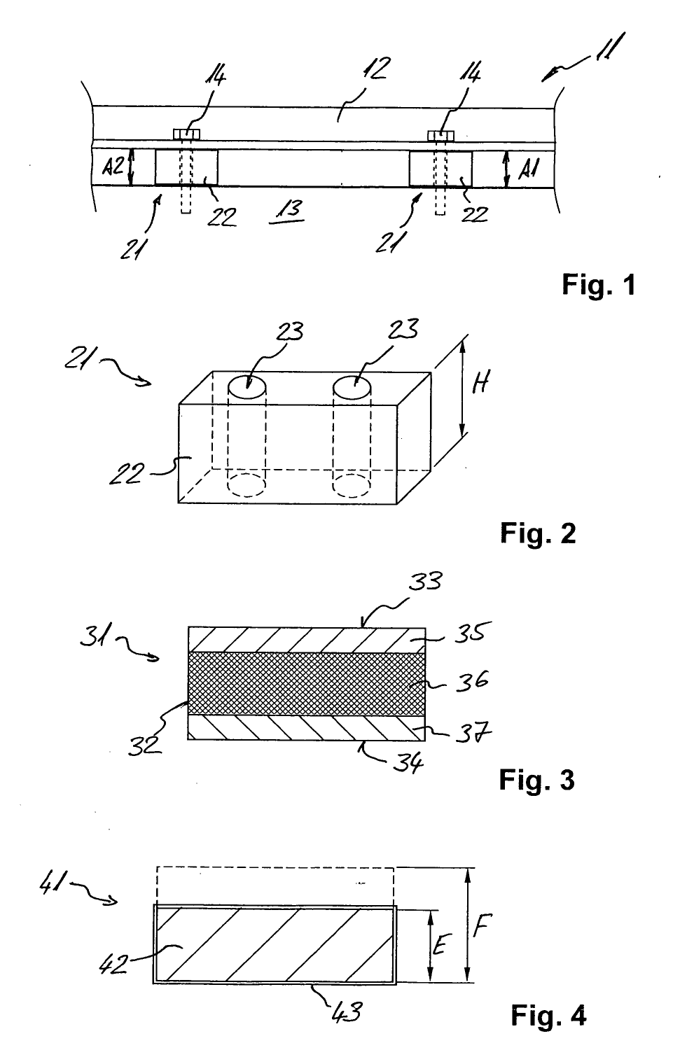

A compensation element 21 according to the present invention for leveling a add-on part 12 relative to a constructional component 13, which is shown in a mounted condition in FIG. 1 and in dismounted condition in FIG. 2, has an elastic base body 22 that is formed, preferably, as a foam body with open pores and a curable material that fills the pores.

The base body 22 and, thus, the compensation element 21, has, in the dismounted condition, a height H. The base body 22 further has a compressibility up to 80% and a constant spring stiffness. In the base body 22, there are provided two through-openings 23 for fastening elements 14.

The base body 22 is soaked with fluid as a curable material and is further provided with a fire-retardant.

The base body 22 is formed, e.g., of foamed thermoset, foamed elastomer, or foamed thermoplast. Suitable theremosets are, e.g., hardened epoxide, silicon, or polyurethane. Suitable foamed elastomers, .e.g., are, from the group of TPE-U/TPU (e.g., TPE-O or TPO=thermoplastic elastomers on an olefin basis), mainly, PP/EPDM e.g. Santroprene™ (Firm AES/Monsato); TPE-V or TPV=cross-linked thermoplastic elastomers on an olefin basis, mainly PP/EPDM, e.g., Sarlink® (firm DSM), Forprene® (firm SoFter); TPE-U or TPU=thermoplastic elastomers on a urethane basis, e.g., Desmopan®, Texin®, Utechllan® (firm Bayer), TPE-E or TPC—thermoplastic copolyesters, e.g., Hytrel® (firm DuPont); TPE-S or TPS=styrene block copolymers (SBS, SEBS, SEPS, SEEPS, and MBS), e.g., Septon™ (firm Kuraray) or Thermoplast-K (firm Kraiburg); TPE-A or TPA=thermoplastic copolyamides, e.g., PEBAX® (firm Arkema). In addition, suitable foamed thermoplasts are, e.g., acrylonitrile-butadiene-styrene (ABS), polyamide (PA), polylactate (PLA), polymethyl methacrylate (PMMA), polycarbonate (PC), polyethylene terephthalate (PET), polyethylene (PE), polypropylene (PP), polysterene (PS), polyetherketon (PEEK) and polyvinylcholoride (PVC).

The curable material is advantageously moisture proof and includes, advantageously, isocyanate, concrete, silicone, or cyanoacrylate. If the curable material is subsequently introduced into the base body 22, the curable material advantageously includes epoxide, vynilether, or thermoplastic adhesive.

For leveling the add-on part 12 relative to the constructional component 13 (see the arrangement in FIG. 1), firstly, there are provided a plurality of compensation elements the number of which corresponds to the number of fastening elements 14 and which are placed on the constructional component 13. Then, the add-on part 12 is placed on the compensation elements 21.

In their non-cured condition, the compensation elements 21 have an inherent stiffness sufficient for receiving the net weight of the add-on part 12. With the fastening elements 14 which are secured in the constructional component 13, the height H of the compensation elements 21 is reduced to a necessary reduced height A1 or A2 for leveling the building attachment part 12. Dependent on the alignment of the constructional component 13, e.g., the precision of the surface of the constructional component 13, the compensation elements 21 would have in their mounted condition different degrees of compression and, thus, different reduced heights A1 or A2.

Advantageously, the curing process of the curable material already starts during mounting of the compensation element 21, so that the compensation element 21 remains further compressible and flexible for a predetermined time period at least at the start of the curing period.

After the curable material is cured, the compensation element 21 has a high stiffness and can be loaded with a total load.

A compensation element 31, which is shown in FIG. 3, has a multi-layer, in the present case, a three-layer elastic base body 32 of which at least the layer 35 and 36 or 36 and 37 have different volume densities. The layer 35, which is provided on an outer surface 33 of the base body 32, has a smaller volume density than the middle layer 36 adjacent thereto. The layer 37, which is provided on another, opposite side 34 of the base body 32, also has a smaller volume density than the middle layer 36 adjacent thereto. As a result, the outer layers 35 and 37 are weaker in comparison with the middle layer 36 and can be equally easily adapted to the structure of a corresponding surface of the constructional component 13 and to the structure of a corresponding surface of the building add-on part 12. In this embodiment, all of the layers 35, 36, and 37 are formed of a foam body with open pores and that has the volume density corresponding to respective predetermined characteristics. In each layer 35, 36, and 37, there is provided a predetermined amount of a curable material corresponding to a respective volume, so that the base body 32 is cured in its entirety to form a solid body.

A compensation element 41, which is shown in FIG. 4, also has an elastic base body 42 formed as a foam body with open pores which is soaked with a fluid curable material. The curable material has a fluid that reacts upon contact with air. The base body 42 is compressible to a height E that corresponds to about two/third of an initial height H1 of the base body 42 (as shown with hatching). The compressed base body 42 is held, in its compressed condition, completely by removable holding means 43 and is air-tight sealed thereby.

After removal of the holding means 43, the base body 42 expands due to its resiliency to the initial height F. Upon expansion of the soaked base body 42, the air penetrates into the interior of the base body 42, whereby curing of the fluid that reacts upon contact with air, starts. In this condition for the compensation element 41, it still remains flexible and allows an easy alignment of the to-be-leveled building add-on part 12. After completion of curing process, the compensation element 41 is able to transmit the load generated during an operation.

Though the present invention was shown and described with references to the preferred embodiments, such are merely illustrative of the present invention and are not to be construed as a limitation thereof and various modifications of the present invention will be apparent to those skilled in the art. It is, therefore, not intended that the present invention be limited to the disclosed embodiments or details thereof, and the present invention includes all variations and/or alternative embodiments within the spirit and scope of the present invention as defined by the appended claims.

What is claimed is:

1. A compensation element for leveling an add-on part (12) relative to a constructional component (13), comprising an elastic base body (22; 32; 42) formed as a porous foam body; and a curable material provided in the pores of the base body (22; 32; 42).

2. A compensation element according to claim 1, wherein the porous foam body is formed with open pores.

3. A compensation element according to claim 1, wherein the base body (32) is formed as a multi-layer body at least two layers of which (35, 36, 37) have respective different volume densities.

4. A compensation element according to claim 3, wherein a layer (35, 37), which is provided on an outer surface (33, 34) of the base body (32), has a smaller volume density than an adjacent layer (36) of the base body (32).

5. A compensation element according to claim 1, wherein the curable material is fluid.

6. A compensation element according to claim 5, wherein the base body (22; 32; 42) is soaked with the curable fluid material.

7. A compensation element according to claim 5, wherein the fluid becomes reactive upon contact with air, and the base body (42) is air-tightly sealed.

8. A compensation element according to claim 1, wherein the base body (42) is compressible, and wherein the compensation element comprises removable holding means for retaining the base body (42) in a compressed condition.

9. A compensation element according to claim 1, wherein the base body (22) is provided with a fire-retardant.

10. A compensation element according to claim 1, wherein the base body (22) is provided with at least one through-opening (23) for a fastening element (14).
